(19) United States
(12) Patent Application Publication
(10) Pub. No.: US 2008/0172668 A1
(43) Pub. Date: Jul. 17, 2008

(54) PROFILE-BASED CPU/CORE AFFINITY

(76) Inventor: Yoav M. Tzruya, Even Yehuda (IL)

Correspondence Address: FIALA & WEAVER, P.L.L.C.;C/O INTELLEVATE, P.O. BOX 52050, MINNEAPOLIS, MN, 55402, US

(21) Appl. No.: 11/764,022

(22) Filed: Jun. 15, 2007

Related U.S. Application Data
(60) Provisional application No. 60/880,007, filed on Jan. 12, 2007.

(51) Int. Cl. G06F 9/46

(52) U.S. Cl. 718/101

(57) ABSTRACT

An automated system and method is provided for optimizing utilization of multiple processing resources available within a computer system by an application executing on the computer system. The multiple processing resources may include multiple CPUs or multiple cores within one or more CPUs. Activities performed by the application during execution are monitored. A database is then accessed to obtain processing load information correlated with a particular one of the monitored activities. A projected processing load is then determined based on the obtained processing load information. A sequence of instructions associated with the application is then selectively assigned to one of the multiple processing resources based on the determined projected processing load. The sequence of instructions may be a process or thread associated with the application.

### CROSS-REFERENCE TO RELATED APPLICATIONS

This application claims priority to provisional U.S. Patent Application No. 60/880,007, filed Jan. 12, 2007 and entitled “Profile Based CPU/Core Affinity,” the entirety of which is incorporated by reference herein.

### BACKGROUND OF THE INVENTION

1. Field of the Invention

The invention generally relates to processor resource utilization by a software application. In particular, the invention relates to a system and method that optimizes utilization of multiple processing resources available within a computer system by a software application executing on the computer system.

2. Background

The recent proliferation of central processing units (CPUs) with multiple cores as well as multi-CPU machines has greatly increased the available processing power of many computers, including personal computers (PCs). The common availability of such CPU architectures has led to advances in software optimizations directed to using the additional CPU processing cycles. Typically, such optimizations are accomplished at an operating system (OS) level, or by a software application optimized by a software developer during the development stage to maximize use of all available CPU resources.

When a process is launched, a simple optimization implemented in an OS determines the association (or “affinity”) of the process to a particular CPU or core (or both, in systems equipped with multiple multi-core CPUs). Such an affinity determination can be made, for example, by identifying the CPU or core with the least utilization (or “load”) by other processes. Such an arrangement works reasonably well assuming constant CPU usage by all processes.

A more advanced OS may be capable of reassigning a process from one CPU or core to another CPU or core during execution of the process. Such a reassignment may be dependent on, for example, the total load on the CPU the process is currently assigned to relative to the load of a potential target CPU. For processes comprising several threads of execution, an even more advanced OS may be capable of reassigning individual threads from a CPU or core to another CPU or core. Similarly, a capable OS can assign an initial affinity for a thread that differs from the affinity of other threads launched by the same application.

Conventional algorithms used to determine the affinity for processes or threads typically rely on heuristics and previous process or thread behavior. For example, a conventional algorithm may consider the average CPU consumption of a process or thread over an immediately preceding time span. Based on this statistic, the algorithm then attempts to forecast future processor resource consumption. With proper selection of heuristics, such an algorithm may provide reasonably accurate forecasts in a fair number of cases. However, there would still be cases in which the forecasts were inaccurate. This is because an algorithm implemented in this manner simply cannot know how a process or thread will actually behave once it goes into execution during a context switch.

Accordingly, what is needed is an improved means for accurately forecasting future process and thread behavior in order to better utilize processing resources within a computer system.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

An automated system and method for optimizing utilization of multiple processing resources available within a computer system by an application executing on the computer system is described herein. The automated system and method utilizes an improved means for accurately forecasting future process and thread behavior in order to better utilize the multiple processing resources available within the computer system.

In particular, an automated method for optimizing utilization of a multiple processing resources available within a computer system by an application executing on the computer system is described herein. The multiple processing resources may include multiple CPUs or multiple cores within one or more CPUs. In accordance with the method, activities performed by the application during execution are monitored. A database is then accessed to obtain processing load information correlated with a particular one of the monitored activities. A projected processing load is then determined based on the obtained processing load information. A sequence of instructions associated with the application is then selectively assigned to one of the multiple processing resources based on the determined projected processing load. The sequence of instructions may be a process or thread associated with the application.

The foregoing method may further include tracking processing loads generated by sequences of instructions associated with the application during execution in a staging environment. Activities performed by the application during execution in the staging environment are also tracked. The tracked processing loads are then correlated with the tracked activities to generate correlated processing load and activities information. At least a portion of the correlated processing load and activities information is used to populate the database.

Also described herein is a computer program product comprising a computer-readable medium having computer program logic recorded thereon for enabling a processing unit to optimize utilization of multiple processing resources by an application. The multiple processing resources may include multiple CPUs or multiple cores within one or more CPUs. The computer program logic includes first, second, third and fourth means. The first means are for enabling the processing unit to monitor activities performed by the application during execution. The second means are for enabling the processing unit to access a database to obtain processing load information correlated with a particular one of the monitored activities. The third means are for enabling the processing unit to determine a projected processing load based on the obtained processing load information. The fourth means are for enabling the processing unit to selectively assign a sequence of instructions associated with the application to one of the multiple processing resources based on the determined projected processing load. The sequence of instructions may be a process or thread associated with the application.

Also described herein is a computer program product comprising a computer-readable medium having computer program logic recorded thereon for enabling a processing unit to populate a database that is used to optimize utilization of multiple processing resources by an application. The computer program logic includes first, second third and fourth means. The first means are for enabling the processing unit to track processing loads generated by sequences of instructions associated with the application during execution in a staging environment. The second means are for enabling the processing unit to track activities performed by the application during execution in the staging environment. The third means are for enabling the processing unit to correlate the tracked processing loads with the tracked activities to generate correlated processing load and activities information. The fourth means are for enabling the processing unit to use at least a portion of the correlated processing load and activities information to populate the database.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a high-level diagram of a system that is operable to perform a method for optimizing utilization of a plurality of processing resources available within a computer system by an application executing on the computer system in accordance with an embodiment of the present invention.

FIG. 2 is a flowchart of a method for correlating activities performed by an application executing on a computer system with a processing load in accordance with an embodiment of the present invention.

FIG. 3 depicts a flowchart of a method for generating and storing separate sets of correlation information for each of a plurality of different configurations of staging environment 102 in accordance with an embodiment of the present invention.

FIG. 4 is a flowchart of a method for accessing processing load information associated with a monitored activity of an executing software application and making an affinity determination based on such information in accordance with an embodiment of the present invention.

FIG. 5 is a block diagram of an example implementation of the system of FIG. 1 in accordance with one embodiment of the present invention.

FIG. 6 depicts an exemplary computer system that may be used to implement a staging environment or a production environment in accordance with an embodiment of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Overview

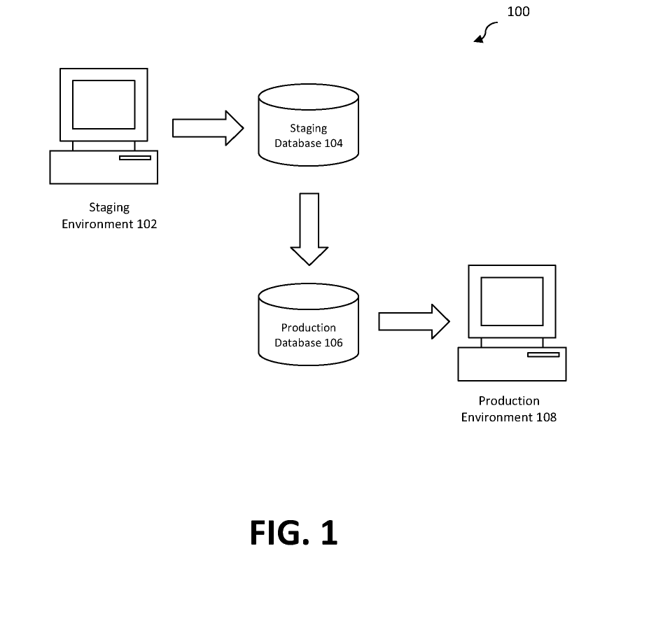

FIG. 1 depicts an example system 100 which is operable to perform a method for optimizing utilization of a plurality of processing resources available within a computer system by a software application executing on the computer system in accordance with an embodiment of the present invention. As shown in FIG. 1, system 100 includes both a staging environment 102 and a production environment 108. Staging environment 102 and production environment 108 may each include a computer system that includes multiple processing resources for executing software applications. For example, each of staging environment 102 and production environment 108 may be a computer system having multiple CPUs or multiple cores within one or more CPUs.

Staging environment 102 is used by a system administrator or other entity to perform operations that must occur in order to facilitate operations that will later be performed on behalf of a user in production environment 108. In particular, and as will be explained in more detail herein, staging environment 102 is used by a system administrator or other entity to monitor a software application, such as a video game, during execution to track activities performed by the software application as well as to track the level of utilization of the available processing resources of staging environment 102 (generally referred to herein as the “processing load”). Information about each tracked activity is correlated with a processing load. This correlation information is stored in a staging database 104.

After staging database 104 has been populated, the hardware and/or software characteristics of staging environment 102 may be altered, or a different staging environment 102 used altogether, in order to produce additional sets of correlation information for storage in staging database 104. Each set of correlation information from staging database 104 together with profile information concerning particular hardware and/or software characteristics of the staging environment 102 used to generate such information are stored in a production database 106. Thus, each set of correlation information stored in production database 106 may be associated with a particular system profile.

Production environment 108 represents the environment in which an end-user actually executes the software application. The software application is the “same” as the application executed in staging environment 102 in that it is another copy or instance of essentially the same computer program, although it need not be completely identical. As will be described in more detail herein, production environment 108 monitors the execution of the software application and detects certain activities performed by the application during such execution. Information concerning these activities is used to access production database 106 and obtain processing load information correlated with such activities. The processing load information obtained may also be selected based on a system profile when such profile information is stored in production database 106.

The processing load information obtained from production database 106 is used by production environment 108 to determine a projected processing load. The projected processing load is used by production environment 108 to determine the affinity between a newly-created process or thread and one of multiple available processing resources. Alternatively, the projected processing load may be used by production environment 108 to switch the affinity of a currently-executing or halted process or thread from a first processing resource to a second processing resource.

An example computer system that may be used to implement either staging environment 102 or production environment 108 will be described in detail in Section E, below, although the invention is not limited to any particular computer system implementation. Furthermore, persons skilled in the relevant art(s) will readily appreciate that each of staging database 104 and production database 106 can be implemented using one or more of any of a wide variety of known physical and logical structures for storing digital information. Such databases may be located locally or remotely with respect to staging environment 102 and production environment 108, respectively.

B. Staging Environment Activity Monitoring and Processing Load Correlation in Accordance with an Embodiment of the Present Invention

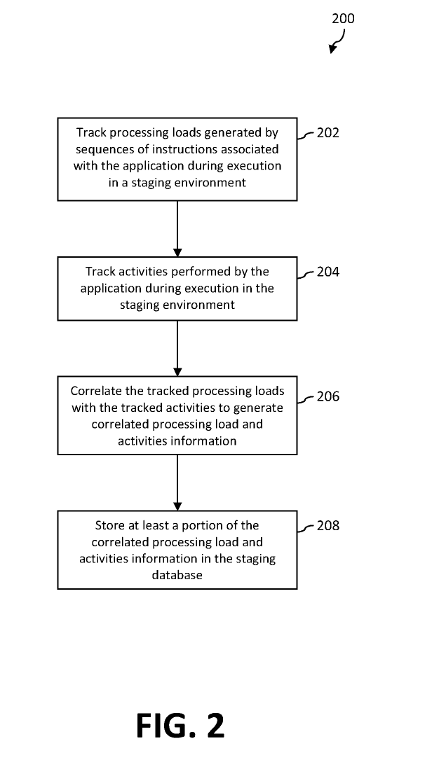

As discussed above, staging environment 102 is configured to monitor a software application, such as a video game, executing on a computer system to track activities performed by the application as well as to track the level of utilization of the available processing resources of the computer system, and to correlate such activities with such processor resource utilization information. This functionality will now be described with reference to flowchart 200 of FIG. 2.

As shown in FIG. 2, the method of flowchart 200 begins at step 202 in which staging environment 102 monitors a software application, such as a video game, during execution in order to track processing loads generated by sequences of instructions associated with the software application. Such tracking occurs over the course of execution of the software application.

Tracking processing loads may comprise tracking a level of utilization of one or more processing resources available within staging environment 102. As noted above, staging environment 102 may comprise a plurality of processing resources. For example, in accordance with one embodiment of the present invention, staging environment 102 comprises a single CPU having multiple processing cores. In accordance with an alternative embodiment of the present invention, staging environment 102 comprises multiple CPUs, each CPU having a single processing core. In accordance with an additional alternative embodiment of the present invention, staging environment 102 comprises multiple CPUs, each CPU having multiple processing cores.

The sequences of instructions associated with the software application may include processes or threads launched by the software application during execution. Each process or thread may be associated with a particular processing resource, such as a particular CPU, or a particular processing core. During step 202, staging environment 102 monitors the performance of any such threads and processes associated with the software application. In accordance with an embodiment of the present invention, processor utilization data is maintained for each individual process or thread.

At step 204, staging environment 102 monitors the software application during execution in order to track activities performed by the application. This step may include determining when particular activities are performed by a sequence of instructions, such as a process or thread, associated with the application. The activities tracked in this manner may include, for example, input/output (I/O) operations associated with the application (including but not limited to user I/O operations), graphics function calls issued by the application, audio function calls issued by the application, network communication operations of the application, or disk and/or file access operations of the application. Network communication operations of the application may include establishing, terminating or utilizing the communications capabilities of a communications device available to staging environment 102. Disk and/or file access operations of the application may include attempts to read or write from a hard disk drive (HDD). However, these examples are not intended to be limiting and persons skilled in the relevant art(s) will appreciate that any activity of the software application that causes a change of state in the staging environment 102 may be tracked during step 204.

Steps 202 and 204 are performed by staging environment 102 for a length of time that is sufficient to create a statistically significant data sample that reveals a correlation between the activities tracked during step 204 and the subsequent processing loads tracked at step 202. This correlation is performed during step 206. Persons skilled in the relevant art(s) will appreciate that while a statistically significant data sample can be used to reveal the correlation, the correlation itself is not a statistical product and is deterministic in nature. For example, a software application that utilizes a processing resource to calculate Pi to a certain number of digits will always generate the same processing load each time it runs, and therefore this correlation is deterministic. However, a statistically significant data sample is necessary in order to allow the correlation data to encompass many parameters that may affect the performance of the software application and that are not known to the staging environment. Accordingly, for each activity that is correlated, the occurrence of the activity in a production environment will have a high likelihood of causing processor utilization levels to roughly equal those correlated with it.

One straightforward method for creating a correlation between tracked activities and processing loads is to link an activity with a processing load if the activity and processing load occur in close timing with one another on a statistically significant number of occasions during execution of the software application. Persons skilled in the relevant art(s) will readily appreciate that what constitutes close timing and what constitutes a statistically significant number of occasions may vary from implementation to implementation.

At step 208, staging environment stores at least a portion of the correlated processing load and activities information (also referred to herein as “correlation information”) generated in step 206 in staging database 104 for later access and retrieval.

The manner in which the steps of flowchart 200 are performed by staging environment 102 may differ in various implementations. In accordance with one embodiment of the present invention, the method comprising the steps of flowchart 200 is implemented in the kernel of an OS upon which the application is executed. In accordance with another embodiment of the present invention, the method is implemented by a hook on system or kernel context switching functions. In accordance with an additional embodiment of the present invention, the method is implemented by a daemon or other program running as a background process that uses OS calls to periodically perform the steps of flowchart 200. In accordance with a further embodiment of the present invention, the software application is instrumented in order to add in-line machine code which performs the method. In accordance with yet another embodiment of the present invention, application developers are provided with software development kits (SDKs) or application programming interfaces (APIs) by which they can build the method into an application at development time. Persons skilled in the relevant art(s) will appreciate that further implementations of the steps of flowchart 200 are possible, and that the foregoing implementations are provided by way of example only. Such example implementations are not intended to limit the present invention.

The correlation information generated by the method of flowchart 200 may vary in a manner that is dependent on the particular hardware and/or software configuration of staging environment 102. For example, a staging environment 102 with less random access memory (RAM) may be required to swap memory during the course of executing the software application, and would be expected to experience different processor utilization levels accordingly. Other changes to hardware, such as CPU power, number of cores in a CPU, and the number of CPUs may also have an impact. Furthermore, changes to software and software parameters, such as the particular OS being used, the manner in which the software application is executed, and available HDD space for temporary data storage may affect performance.

In order to account for the fact that correlation information generated by the method of flowchart 200 may vary depending on hardware and/or software configuration differences, an embodiment of the present invention generates a separate set of correlation information for each of a plurality of different configurations of staging environment 102. Each set of correlation information is then stored in association with profile information that describes the hardware and/or software configuration that was used to generate the data. Such correlation information and associated profile information may be stored in production database 106 for use by production environment 108 in a manner to be described in more detail below.

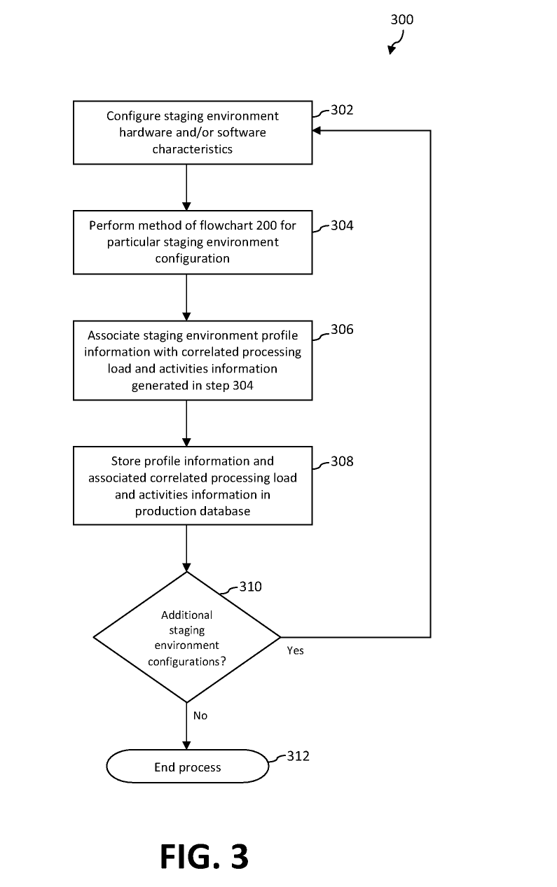

FIG. 3 depicts a flowchart 300 of a method for generating and storing separate sets of correlation information for each of a plurality of different hardware and/or software configurations of staging environment 102 in accordance with an embodiment of the present invention.

As shown in FIG. 3, the method of flowchart 300 begins at step 302, in which a system administrator or other entity configures the hardware and/or software characteristics of staging environment 102. This step may include altering the hardware and/or software characteristics of an existing staging environment 102 or using or installing an entirely new staging environment 102.

At step 304, the steps of flowchart 200 as described above in reference to FIG. 2 are performed for the particular staging environment configuration that was set up in step 302. As discussed above, the performance of these steps results in the generation of a set of correlated processing load and activities information, which may be stored in staging database 104.

At step 306, profile information that describes the current hardware and/or software configuration of staging environment 102 is associated with the set of correlation information generated in step 304. At step 308, the profile information and associated correlation information are stored together in production database 106 for use in a production environment in a manner that will be described elsewhere herein. Steps 306 and 308 may be performed manually by a system administrator or other entity, automatically by a software application, or via a combination of manual and automated means.

At step 310, a decision is made as to whether there are additional configurations of staging environment 102 for which correlation information should be generated. If there are, then the process starts over again at step 302, during which staging environment 102 is re-configured with a different set of hardware and/or software characteristics. If, however, there are no additional configurations for which correlation information should be generated, then processing ends as shown at step 312.

Assuming that at least two different configurations of staging environment 102 are used, the method of flowchart 300 will result in multiple sets of correlation information being stored in production database 106, each set of correlation information being uniquely associated with a particular hardware and/or software profile. As will be described in more detail herein, production environment 108 may use the profile information stored in production database 106 to identify a set of correlation data that is best suited for a particular hardware and/or software configuration. This is advantageous in an embodiment in which production environment 108 may be implemented using a variety of hardware and/or software configurations.

In an embodiment of the present invention in which the hardware and software configuration to be used in production environment 108 is known, the method of flowchart 300 need not be used. In this case, suitable correlation information may be generated by performing the steps of flowchart 200 using a staging environment 102 that has a comparable configuration to production environment 108. An example of such a scenario is where production environment 108 is a video game console having a known hardware and software configuration.

C. Production Environment Activity Monitoring and Affinity Determination in Accordance with an Embodiment of the Present Invention

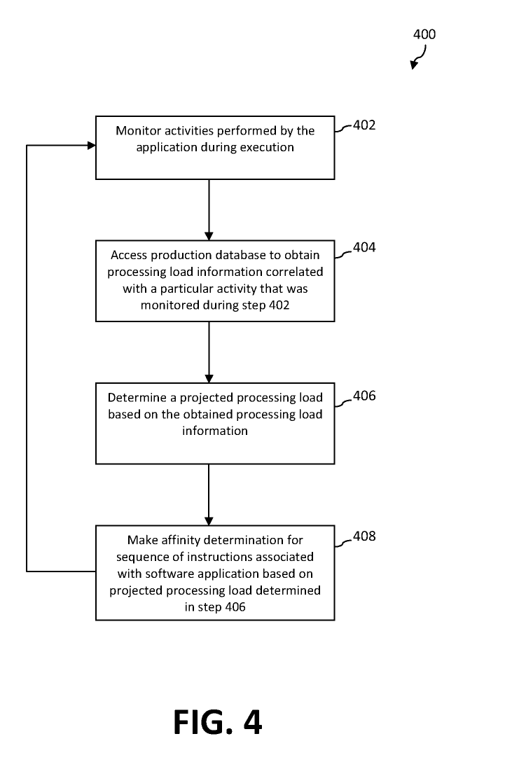

As discussed above in reference to FIG. 1, production environment 108 is configured to monitor activities performed by a software application during execution, to obtain processing load information correlated with the monitored activities, and to make affinity determinations concerning processes or threads launched by the software application based on such correlation information. This functionality will now be described with reference to flowchart 400 of FIG. 4.

As shown in FIG. 4, the method of flowchart 400 begins at step 402, in which production environment 108 monitors a software application, such as a video game, during execution to detect when particular activities are being performed by the application. As discussed above in Section A, the application is the “same” as the application executed in staging environment 102 in that it is another copy or instance of essentially the same computer program, although it need not be completely identical.

The activities being monitored during step 402 include activities tracked in staging environment 102 during step 204 as shown in flowchart 200 of FIG. 2. Thus, the activities monitored may include, for example, I/O operations associated with the application (including but not limited to user I/O operations), graphics function calls issued by the application, audio function calls issued by the application, network communication operations of the application, or disk and/or file access operations of the application. However, these examples are not intended to be limiting and persons skilled in the relevant art(s) will appreciate that any activity of the software application that causes a change of state in the production environment 108 may be monitored during step 402. As noted above, such activities may be performed by processes or threads associated with the executing software application.

At step 404, production environment 108 accesses production database 106 to obtain processing load information correlated with a particular activity that was monitored or detected during step 402. In particular, production environment 108 uses information associated with a particular activity that was monitored or detected during step 402 to query production database 106 to obtain processing load information correlated with the activity information. The activity information used by production environment 108 to query production database 106 is formatted in the same manner in which activity information was stored in staging database 104 during the method of flowchart 200 of FIG. 2.

Production environment 108 may also access processing load information stored in production database 106 based on profile information stored in association with such information as discussed above in reference to step 308 of flowchart 300. The profile information used to access the processing load information may be the profile information that describes a hardware and/or software configuration that matches, or most closely matches, a hardware and/or software configuration of production environment 108.

The hardware configuration parameters of production environment 108 may include a particular memory size, CPU power, number of processing cores, and number of CPUs, although these examples are not intended to be limiting. The software configuration parameters of production environment 108 may include the particular OS upon which the software application is being run and the drivers being used by the software application, although these examples are not intended to be limiting.

In accordance with such an embodiment, profile information that is representative of the hardware and/or software configuration of production environment 108 is generated in a like manner to that used to generate profile information for staging environment 102. Production environment 108 uses this profile information to query production database 106 to obtain a set of correlated processing load and activities information. The set of correlated processing load and activities information obtained is the set that is associated with profile information that matches, or most closely matches, the profile information for production environment 108. After the set of correlated processing load and activities information is obtained, production environment queries this set of information using activity information associated with the activity that was monitored or detected during step 402 to obtain processing load information correlated with the activity information.

At step 406, production environment 108 uses the processing load information obtained in step 404 to determine a processing load about to be generated by the software application to a high degree of certainty. This projection can then be used by an affinity algorithm of the OS kernel and/or CPU of production environment 108.

At step 408, production environment 108 makes an affinity determination for a sequence of instructions associated with the executing software application based on the projected processing load determined in step 406. In particular, based on the projected processing load, production environment 108 assigns a sequence of instructions associated with the executing software application to one of a plurality of processing resources available to production environment 108. The sequence of instructions may comprise a process or thread associated with the executing software application. The plurality of processing resources may comprise a plurality of CPUs or a plurality of cores within one or more CPUs.

The affinity determination of step 408 assigns a process or thread to a particular processor resource based on projected processor consumption levels. By knowing how each process or thread associated with the software application will respond to an activity that has just occurred, as determined in step 402, production environment 108 can determine which processing core and/or CPU is best able to handle the future processing load. In accordance with an embodiment of the present invention, such determination is made by also considering other processes executing in production environment 108. In accordance with a further embodiment of the present invention, future CPU consumption levels are known for two or more processes, and can be considered together. If the expected load on a processing core or CPU by a process or thread will exceed the processing capabilities of that core or CPU, and another core or CPU is available that can better handle the processing of the process or thread, then it is determined that the process or thread should be assigned or re-assigned to the other core or CPU.

Assigning the sequence of instructions associated with the executing software application to one of a plurality of processing resources may comprise assigning an unassigned sequence of instructions to one of the plurality of processing resources. The unassigned sequence of instructions may comprise a process or thread that has not yet launched. Alternatively, assigning the sequence of instructions to one of a plurality of processing resources may also comprise re-assigning a sequence of instructions assigned to a first processing resource to a second resource. The re-assigned sequence of instructions may comprise a process or thread that has already launched on one CPU or core but is being migrated to a different CPU or core. Still further, assigning the sequence of instructions to one of a plurality of processing resources may comprise determining that the sequence of instructions should remain assigned to a CPU or core to which it is currently assigned.

After step 408, monitoring of the execution of the software application resumes as previously described at step 402 until another activity of interest is detected.

The manner in which the steps of flowchart 400 are performed by staging environment 102 may differ in various implementations. In accordance with one embodiment of the present invention, the method comprising the steps of flowchart 400 is implemented in the kernel of an OS upon which the application is executed. In accordance with another embodiment of the present invention, the method is implemented by a hook on system or kernel context switching functions. In accordance with an additional embodiment of the present invention, the method is implemented by a daemon or other program running as a background process that uses OS calls to periodically perform the steps of flowchart 400. In accordance with a further embodiment of the present invention, the software application is instrumented in order to add in-line machine code which performs the method. In accordance with yet another embodiment of the present invention, application developers are provided with software development kits (SDKs) or application programming interfaces (APIs) by which they can build the method into an application at development time. Persons skilled in the relevant art(s) will appreciate that further implementations of the steps of flowchart 400 are possible, and that the foregoing implementations are provided by way of example only. Such example implementations are not intended to limit the present invention.

### D. Example System Details

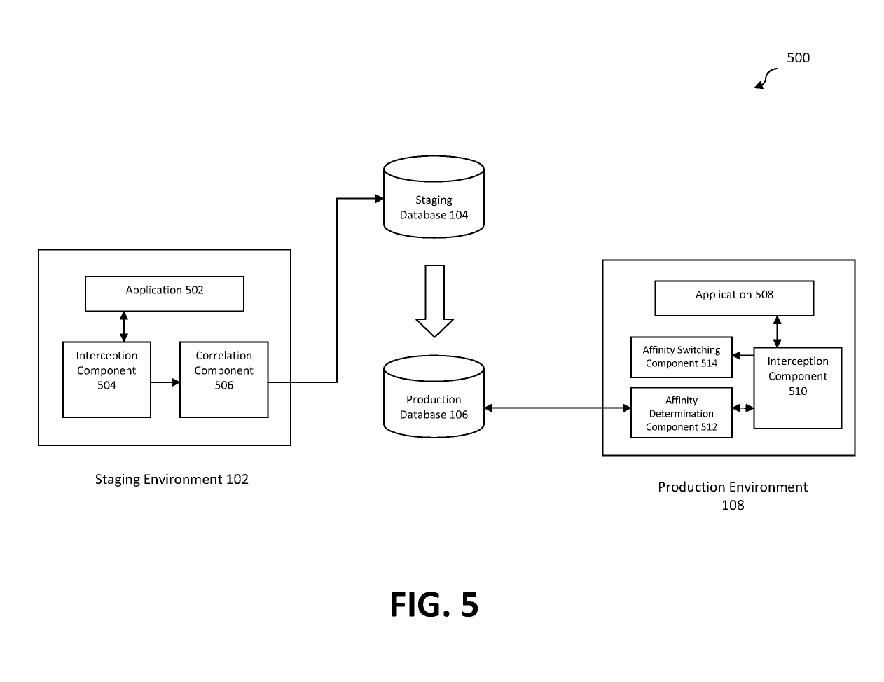

FIG. 5 depicts components of an example system 500 which is operable to perform a method for optimizing utilization of a plurality of processing resources available within a computer system by a software application executing on the computer system in accordance with an embodiment of the present invention. Example system 500 is a specific implementation of system 100 of FIG. 1, and accordingly includes a staging environment 102, staging database 104, production database 106, and production environment 108.

As shown in FIG. 5, staging environment 102 includes a software application 502, an interception component 504, and a correlation component 506. Software application 502 is a computer program that is executing on one or more processing resources within staging environment 102. While software application 502 is executing, interception component 504 operates to intercept function calls generated by application 502 and thereby determine when particular activities are being performed by application 502. Responsive to determining that an activity of interest is being performed by application 502, interception component 504 provides information concerning the activity to correlation component 506. Correlation component 506 operates to correlate information concerning the level of utilization of the processing resources within staging environment 102 with the activity information provided by interception component 504. Correlation component 506 is further configured to store such correlated processing load and activity information in staging database 104.

As further shown in FIG. 5, production environment 108 includes a software application 508, interception component 510, affinity determination component 512, and affinity switching component 514. Software application 508 is a computer program that is executing on one or more processing resources within production environment 108. Software application 508 is another instance of software application 502. While software application 508 is executing, interception component 510 operates to intercept function calls generated by application 508 and thereby determine when particular activities are being performed by application 508. Responsive to determining that an activity of interest is being performed by application 508, interception component 510 provides information concerning the activity to affinity determination component 512. Affinity determination component 512 operates to determine a projected processing load associated with the activity. Affinity determination component 512 determines the projected processing load by first consulting production database 106 using the activity information. Affinity determination component 512 is then able to make an affinity determination for a process or thread associated with application 508. If a determination is made to switch the affinity of a thread or process of application 508, affinity switching component 514 operates to perform the thread or process migration.

In accordance with an embodiment of the present invention, components 512 and 514 are standard OS affinity determination and affinity switching mechanisms augmented with the predictive processing load data. In accordance with an alternative embodiment of the present invention, components 512 and 514 are the built-in OS mechanisms altered to take into account the predictive CPU load data. In accordance with a further embodiment of the present invention components 512 and 514 are newly-built mechanisms that are intended to replace the built-in OS mechanisms. Persons skilled in the relevant art(s) will appreciate that further implementations of components 512 and 514 are possible, and it should be understood that the particular implementations are provided by way of example only, and are not intended to limit the present invention.

### E. Example Computer System Implementation

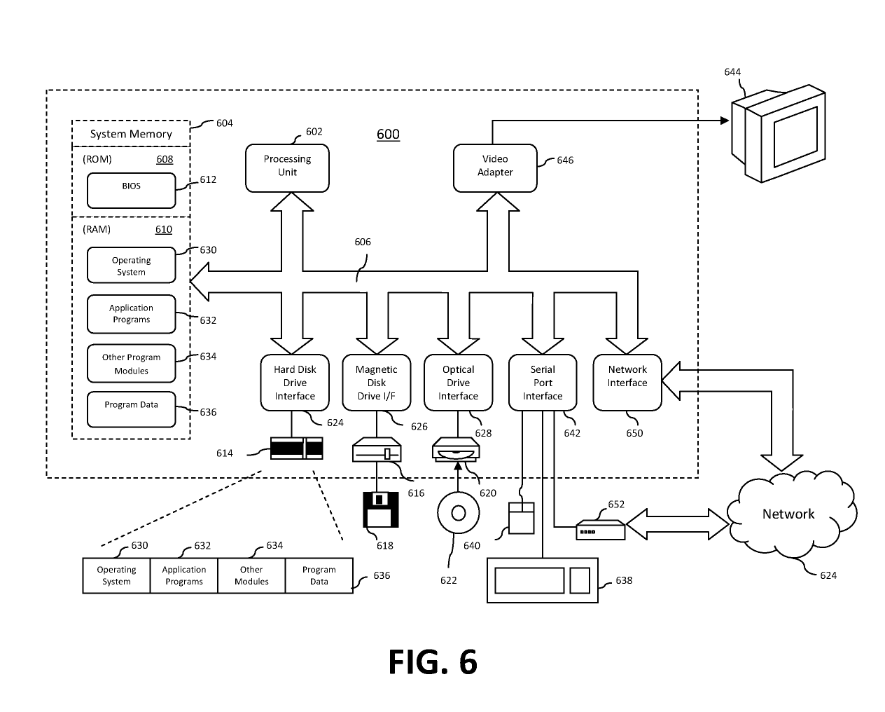

FIG. 6 depicts an exemplary computer system 600 that may be used to implement staging environment 102 or production environment 108.

Computer system 600 may comprise a general-purpose computing device, such as a conventional personal computer, or an interactive entertainment computer or electronic device, such as a video game console, although these examples are not intended to be limiting. Computer system 600 is configured to perform the functions of staging environment 102 or production environment 108 as described elsewhere herein.

As shown in FIG. 6, computer system 600 includes a processing unit 602, a system memory 604, and a bus 606 that couples various system components including system memory 604 to processing unit 602. Processing unit 602 comprises a plurality of processing resources, such as a plurality of CPUs or a plurality of cores within one or more CPUs. Bus 606 represents one or more of any of several types of bus structures, including a memory bus or memory controller, a peripheral bus, an accelerated graphics port, and a processor or local bus using any of a variety of bus architectures. System memory 604 includes read only memory (ROM) 608 and random access memory (RAM) 610. A basic input/output system 612 (BIOS) is stored in ROM 608.

Computer system 600 also has one or more of the following drives: a hard disk drive 614 for reading from and writing to a hard disk, a magnetic disk drive 616 for reading from or writing to a removable magnetic disk 618, and an optical disk drive 620 for reading from or writing to a removable optical disk 622 such as a CD ROM, DVD ROM, or other optical media. Hard disk drive 614, magnetic disk drive 616, and optical disk drive 620 are connected to bus 606 by a hard disk drive interface 624, a magnetic disk drive interface 626, and an optical drive interface 628, respectively. The drives and their associated computer-readable media provide nonvolatile storage of computer-readable instructions, data structures, program modules and other data for computer system 600. Although a hard disk, a removable magnetic disk and a removable optical disk are described, other types of computer-readable media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 630, one or more application programs 632, other program modules 634, and program data 636. Application programs 632 or program modules 634 may include, for example, logic for implementing the elements of the present invention as described above.

A user may enter commands and information into computer system 600 through input devices such as keyboard 638 and pointing device 640. Other input devices (not shown) may include a microphone, joystick, game pad, satellite dish, scanner, or the like. These and other input devices are often connected to the processing unit 602 through a serial port interface 642 that is coupled to bus 606, but may be connected by other interfaces, such as a parallel port, game port, or a universal serial bus (USB).

A monitor 644 or other type of display device is also connected to bus 606 via an interface, such as a video adapter 646. Monitor 644 is used to present a graphical user interface that assists a user/operator in configuring computer system 600. In addition to the monitor, computer system 600 may include other peripheral output devices (not shown) such as speakers and printers.

Computer system 600 is connected to a network 624 (e.g., the Internet) through a network interface or adapter 650, a modem 652, or other means for establishing communications over the network. Modem 652, which may be internal or external, is connected to bus 606 via serial port interface 642.

As used herein, the terms “computer program medium” and “computer-readable medium” are used to generally refer to media such as the hard disk associated with hard disk drive 614, removable magnetic disk 618, removable optical disk 622, as well as other media such as flash memory cards, digital video disks, random access memories (RAMs), read only memories (ROM), and the like.

As noted above, computer programs (including application programs 632 and other program modules 634) may be stored on the hard disk, magnetic disk, optical disk, ROM, or RAM. Such computer programs may also be received via network interface 650 or serial port interface 642. Such computer programs, when executed, enable computer system 600 to implement features of the present invention discussed herein. Accordingly, such computer programs represent controllers of the computer system 600.

The invention is also directed to computer program products comprising software stored on any computer useable medium. Such software, when executed in one or more data processing devices, causes a data processing device(s) to operate as described herein. Embodiments of the present invention employ any computer-useable or computer-readable medium, known now or in the future. Examples of computer-readable mediums include, but are not limited to storage devices (such as RAM, hard drives, floppy disks, CD ROMs, DVD ROMs, zip disks, tapes, magnetic storage devices, optical storage devices, MEMs, nanotechnology-based storage devices, and the like) and communication mediums (such as wired and wireless communication networks, local area networks, wide area networks, intranets, extranets, and the like).

### F. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. An automated method for optimizing utilization of a plurality of processing resources available within a computer system by an application executing on the computer system, comprising:
monitoring activities performed by the application during execution;
accessing a database to obtain processing load information correlated with a particular one of the monitored activities;
determining a projected processing load based on the obtained processing load information; and
selectively assigning a sequence of instructions associated with the application to one of the plurality of processing resources based on the determined projected processing load.

2. The method of claim 1, wherein the plurality of processing resources comprises a plurality of central processing units (CPUs) or a plurality of cores within one or more CPUs.

3. The method of claim 1, wherein selectively assigning a sequence of instructions associated with the application to one of the plurality of processing resources comprises:
selectively assigning one of a process or thread associated with the application to one of the plurality of processing resources.

4. The method of claim 1, wherein monitoring the activities performed by the application during execution comprises at least one of:
monitoring input/output operations of the application;
monitoring graphics function calls of the application;
monitoring audio function calls of the application;
monitoring network communication operations of the application; and
monitoring disk and/or file access operations of the application.

5. The method of claim 1, wherein accessing a database to obtain processing load information correlated with a particular one of the monitored activities comprises:
obtaining the processing load information based in part on profile information stored in the database, wherein such profile information is associated with the processing load information.

6. The method of claim 5, wherein the profile information associated with the processing load information comprises information pertaining to hardware and/or software characteristics of the computer system on which the processing load information was generated.

7. The method of claim 1, wherein selectively assigning a sequence of instructions with one of the plurality of processing resources comprises:
assigning an unassigned sequence of instructions to one of the plurality of processing resources.

8. The method of claim 1, wherein selectively assigning a sequence of instructions with one of the plurality of processing resources comprises:
re-assigning a sequence of instructions assigned to a first processing resource to a second processing resource.

9. The method of claim 1, further comprising:
tracking processing loads generated by sequences of instructions associated with the application during execution in a staging environment;
tracking activities performed by the application during execution in the staging environment;
correlating the tracked processing loads with the tracked activities to generate correlated processing load and activities information; and
using at least a portion of the correlated processing load and activities information to populate the database.

10. The method of claim 9, further comprising:
associating the correlated processing load and activities information with hardware and software profile information associated with the staging environment.

11. The method of claim 1, wherein the method is implemented in one of:
an operating system kernel;
a hook on a context switching function;
a background process;
processing resource management hardware; or
the application itself.

12. A computer program product comprising a computer-readable medium having computer program logic recorded thereon for enabling a processing unit to optimize utilization of a plurality of processing resources by an application, wherein the computer program logic comprises:
first means for enabling the processing unit to monitor activities performed by the application during execution;
second means for enabling the processing unit to access a database to obtain processing load information correlated with a particular one of the monitored activities;
third means for enabling the processing unit to determine a projected processing load based on the obtained processing load information; and
fourth means for enabling the processing unit to selectively assign a sequence of instructions associated with the application to one of the plurality of processing resources based on the determined projected processing load.

13. The computer program product of claim 12, wherein the plurality of processing resources comprises a plurality of central processing units (CPUs) or a plurality of cores within one or more CPUs.

14. The computer program product of claim 12, wherein the fourth means comprises means for enabling the processing unit to selectively assign one of a process or a thread associated with the application to one of the plurality of processing resources based on the determined projected processing load.

15. The computer program product of claim 12, wherein the first means comprises means for monitoring at least one of:
input/output operations of the application;
graphics function calls of the application;
audio function calls of the application;
network communication operations of the application; and
disk and/or file access operations of the application.

16. The computer program product of claim 12, wherein the second means comprises means for enabling the processing unit to obtain the processing load information based in part on profile information stored in the database, wherein such profile information is associated with the processing load information.

17. The computer program product of claim 16, wherein the profile information associated with the processing load information comprises information pertaining to hardware and/or software characteristics of the computer system on which the processing load information was generated.

18. The computer program product of claim 12, wherein the third means comprises means for enabling the processing unit to assign an unassigned sequence of instructions to one of the plurality of processing resources.

19. The computer program product of claim 12, wherein the third means comprises means for enabling the processing unit to re-assign a sequence of instructions assigned to a first processing resource to a second processing resource.

20. A computer program product comprising a computer-readable medium having computer program logic recorded thereon for enabling a processing unit to populate a database that is used to optimize utilization of a plurality of processing resources by an application, wherein the computer program logic comprises:
first means for enabling the processing unit to track processing loads generated by sequences of instructions associated with the application during execution in a staging environment;
second means for enabling the processing unit to track activities performed by the application during execution in the staging environment;
third means for enabling the processing unit to correlate the tracked processing loads with the tracked activities to generate correlated processing load and activities information; and
fourth means for enabling the processing unit to use at least a portion of the correlated processing load and activities information to populate the database.

21. The computer program product of claim 20, further comprising:
fifth means for enabling the processing unit to associate the correlated processing load and activities information with profile information associated with the staging environment.
